(19) United States
(12) Patent Application Publication
(10) Pub. No.: US 2021/0271964 A1
(43) Pub. Date: Sep. 2, 2021

(54) METHODS AND APPARATUS TO PREDICT IN-TAB DROP USING ARTIFICIAL INTELLIGENCE

(71) Applicant: The Nielsen Company (US), LLC, New York, NY (US)

(72) Inventor: Igor Sotosek, Portoroz (SI)

(21) Appl. No.: 16/804,997

(22) Filed: Feb. 28, 2020

(51) Int. Cl. G06N 3/08; G06N 3/04

(52) U.S. Cl. CPC G06N 3/08; G06N 3/04

(57) ABSTRACT

Methods, apparatus, systems and articles of manufacture to predict in-tab drop using artificial intelligence are disclosed. An example apparatus includes an interface to obtain (A) contextual data obtained from servers and (B) validated in-tab totals, the validated in-tab totals corresponding to a number of meters in a location that have transmitted metering data within a threshold duration of time; a filter to filter at least one of the contextual data based on the location; and a model trainer to train a model using filtered contextual data and the validated in-tab totals, the model trainer to train the model to estimate an in-tab total for the location based on input contextual data corresponding to the location.

### FIELD OF THE DISCLOSURE

This disclosure relates generally to artificial intelligence, and, more particularly, to methods and apparatus to predict in-tab drop using artificial intelligence.

### BACKGROUND

When an audience measurement entity enlists panelists to be part of a panel, the audience measurement entity may provide the panelist with a meter to collect data related to media that the panelist and/or household members are exposed to. A meter is considered to be in-tab when the meter transmits collected data to a server of the audience measurement entity within a threshold amount of time. However, if the meter is turned off, powered down, has a technical problem, etc., the meter will not transmit collected data. Such meters are considered to be out-of-tab.

### BRIEF DESCRIPTION OF THE FIGURES

FIG. 1 illustrates an example in-tab monitoring environment structured according to the teachings of this disclosure to predict in-tab drop using artificial intelligence.

FIG. 2 is a block diagram of an example implementation of the in-tab analyzer of FIG. 1.

FIG. 3 is a flowchart representative of machine readable instructions which may be executed to implement the example in-tab analyzer of FIGS. 1 and/or 2 to train a neural network using in-tab data and contextual data.

FIG. 4 is a flowchart representative of machine readable instructions which may be executed to implement the example in-tab analyzer of FIGS. 1 and/or 2 to estimate in-tab totals based on contextual data.

FIG. 5 is a block diagram of an example processing platform structured to execute the instructions of FIGS. 3-4 to implement the example in-tab analyzer of FIGS. 1 and/or 2.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

When a client (e.g., an advertiser, a media creator, etc.) enters into a service level agreement with an audience measurement entity (e.g., The Nielsen Company (US), LLC.), the audience measurement entity may agree to provide the client with information corresponding to media exposure of panelists enlisted in a panel. Panelists, or monitored panelists, are audience members (e.g., household members, users, etc.) enlisted to be monitored, who divulge and/or otherwise share their media activity and/or demographic data (e.g., race, age, income, home location, education level, gender, etc.) to facilitate a market research study.

The AME typically monitors media presentation activity (e.g., viewing, listening, etc.) of the monitored panelists via audience measurement system(s), such as a metering device(s), a portable people meter (PPM) (also known as portable metering devices and portable personal meters), and/or a local people meter (LPM). Audience measurement typically includes determining the identity of the media being presented on a media output device (e.g., a television, a radio, a computer, etc.), determining data related to the media (e.g., presentation duration data, timestamps, radio data, etc.), determining demographic information of an audience, and/or determining which members of a household are associated with (e.g., have been exposed to) a media presentation. For example, an LPM in communication with an audience measurement entity communicates audience measurement (e.g., metering) data to the audience measurement entity. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

In some examples, the service level agreement sets forth that a threshold number of panelist and/or a threshold number of panelists households be in-tab within a region and/or during a duration of time. A panelist and/or panelist household is in-tab when the meter(s) associated with the panelist and/or panelist household transmits media exposure data to the audience measurement entity within a duration of time. A panelist and/or panelist household is out-of-tab when the meter(s) associated with the panelist and/or panelist household do not transmit media exposure data to the audience measurement entity within a threshold period of time. A panelist may be out-of-tab when the meter is powered down (e.g., when unplugged, during a power outage, and/or after a battery of the meter dies) or when there is a technical problem with the meter.

Although a panelist may agree to keep their meter plugged in, there may be a plurality of reasons why a panelist and/or panelist household may go (e.g., drop) out-of-tab. For example, certain regions may have environmental laws that require households to unplug devices that are not in use for more than a threshold amount of time (e.g., when a family goes on vacation) which may be longer than the duration of any backup battery that may power the meter, a power failure may occur, a failure of a battery backup system may occur, a panelist may voluntarily unplug a meter to conserve power (e.g., unplug the meter when the panelist goes on vacation) and/or for safety reasons (e.g., a flood occurring that may cause safety issues if the power is not shut down), a panelist and/or non-panelist in a home may accidently unplug a meter and/or not realize that they are unplugging a meter, a region may encounter a power loss (e.g., a blackout), etc. Accordingly, when the panel experiences an in-tab drop that results in the total number in-tab panelists and/or panel households being below a threshold, the audience measurement entity may contact the client to let them know of the in-tab drop and/or provide possible reasons for the in-tab drop. However, traditionally, the audience measurement entity may not be aware of the reason for the in-tab (e.g., faulty equipment, environmental laws, vacation season, power outage, political and/or natural events (e.g., protesting, political instability, floods, hurricanes, etc.).

Examples disclosed herein predict in-tab drop for a particular region and/or a particular duration of time based on contextual information obtained from a network (e.g., the Internet) or other source. The contextual information may be weather data of the particular region, weather data of surrounding regions, political and/or safety data for the particular region and/or surrounding regions, travel advertisements in the particular region, travel blogs, hotel reservation information for surrounding regions, plane reservation information corresponding to the particular region, market and/or financial information corresponding to the particular region and/or surrounding regions, emergency information corresponding to the particular region and/or surrounding regions, any other information that may correspond to an increase or decrease in travel of people in the particular region, environmental laws, environmental protocols, blogs related to environmental initiates, and/or any other information that may correspond to an increase or decrease in panelists voluntarily turning off meter(s) (e.g., becoming out-of-tab).

Examples disclosed herein utilize artificial intelligence (AI) to predict in-tab totals (e.g., total number of estimated in tab meters and/or total percentage of in-tab meters for the particular location and/or particular duration of time) and/or in-tab drop (e.g., the amount of in-tab drop from one period of time to a subsequent period of time) based on such contextual information. In some examples, a model (e.g., a neural network) may be trained based on in-tab data and contextual data obtained within a threshold duration of time from when the in-tab data was received to be able to predict in-tab totals and/or in-tab drop based on the contextual data. Once trained, the model can utilize subsequent contextual data to generate a corresponding in-tab total estimate and/or an in-tab drop. For example, if the contextual data corresponds to an influx of flight advertisements in Canada for cheap flights to the Caribbean during the winter, the model may estimate that an in-tab drop may occur because, during training, Canadian panelists travelled to warmer regions and turned off the meter in their household when flights to the Caribbean were priced low. In another example, if a large percentage of citizens in Stockholm typically travel to Greece in August, but there is news of political protests and/or an economic crash in Greece, the model may be trained to predict less in-tab drop because, during training, panelists did not travel when Greece had social-economic problems.

Because examples disclosed herein predict in-tab drop, an audience measurement entity can predict in-tab drop that will result in in-tab totals being less than a threshold amount defined in a service level agreement and send a message to the client to warn the client of the possible in-tab drop. Examples disclosed herein further include performing explainability on the model to identify the reason(s) for the predicted in-tab drop. Explainability is a technique that provides understanding as to how an AI-assisted system/model generated an output. For example, if an AI-assisted system processes contextual data to generate an output (e.g., an estimate in-tab total and/or an estimated in-tab drop), explainability identifies the factors that the AI-assisted system focused on to generate the output. Explainability may be implemented using gradient weighted class activation mapping (Grad-CAM), local interpretable model-agnostic explanations (LIME), and/or any other explainability technique.

Additionally, examples disclosed herein compare an estimated in-tab total and/or in-tab drop to the actual in-tab total and/or in-tab drop to determine whether there is a technical problem with one or more of the meters. For example, if the estimated in-tab is 95% of the meters and only 75% of the meters transmit data to the audience measurement entity, example disclosed herein determine that there is a technical problem with the meters. In this manner, examples disclosed herein can flag the large in-tab drop and/or transmit instructions to the meter to perform diagnostic and/or perform over-the-air updates to the software of the meters to attempt to identify and/or resolve the technical issues of the meters.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a neural network model is used. In general, machine learning models/architectures that are suitable to use in the example approaches disclosed herein will be neural network based models (e.g., convolution neural network (CNN), deep neural network (DNN), etc.) including explainability to be able to determine which factors were important for the neural network based model in generating an output, of a graph neural network (GNN) that provides some insight into the inner structure of the network model. However, other types of machine learning models could additionally or alternatively be used such as deep learning and/or any other type of AI-based model.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using in-tab data from panelist meters and contextual data from servers in a network. However, any other training algorithm may additionally or alternatively be used. In examples disclosed herein, training is performed until an acceptable amount of error is achieved. In examples disclosed herein, training is performed at a server of the audience measurement entity. Training is performed using hyperparameters that control how the learning is performed (e.g., a learning rate, a number of layers to be used in the machine learning model, etc.). In some examples re-training may be performed. Such re-training may be performed in response to additional in-tab data, additional contextual data, changes in the panel and/or changes in the contextual data.

Training is performed using training data. In examples disclosed herein, the training data originates from panel meters and/or servers on a network. Because supervised training is used, the training data is labeled. Labeling is applied to the training data by an audience measurement entity and/or by the servers.

Once training is complete, the model is deployed for use as an executable construct that processes an input and provides an output based on the network of nodes and connections defined in the model. The model is stored at the server of the audience measurement entity. The model may then be executed by an in-tab analyzer of the audience measurement entity to estimate in-tab totals based on input contextual data.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

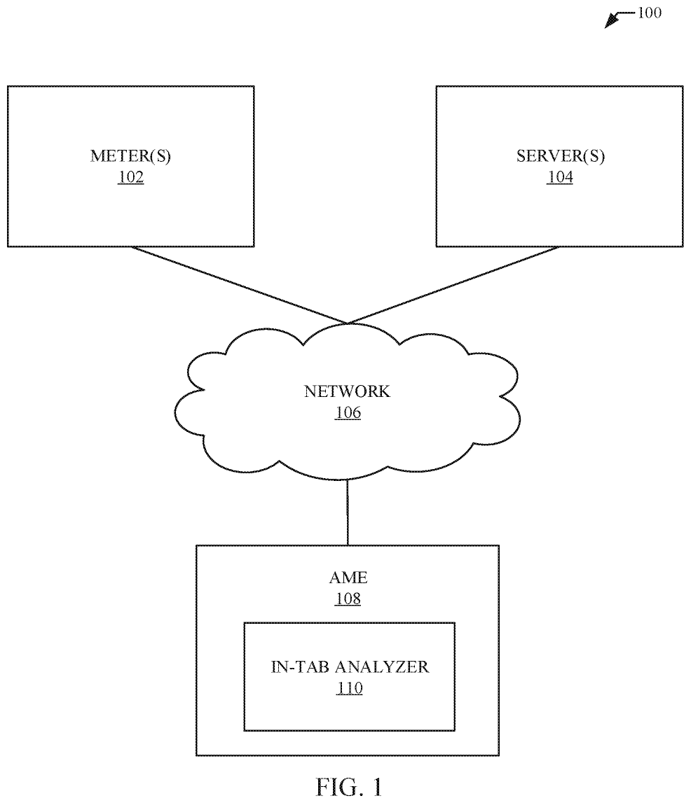

FIG. 1 illustrates an example in-tab monitoring environment 100. The example in-tab monitoring environment 100 of FIG. 1 includes an example meter(s) 102, an example server(s) 104, an example network 106, and an example audience measurement entity (AME) 108. The AME 108 includes an example in-tab analyzer 110.

The example meter(s) 102 of FIG. 1 is/are LPM(s) and/or PPM(s) that may be installed at a user (e.g., panelist) location (e.g., panelist household) and/or carried with the user to monitor media exposure behavior(s) of users at a location. In some examples, the meter(s) 102 may be a computer(s), a cell phone(s), and/or any other meter(s) that may be coupled to any type of modem device. In some examples, the example meter(s) 102 monitor(s) household media and/or household member behaviors. In some examples, the meter(s) 102 is/are communicatively coupled (e.g., wired or wireless) to television, a computing device, a set-top-box, a mobile device, a tablet, and/or any other device that receives and/or presents media. In some examples, the meter(s) 102 include(s) a microphone to intercept ambient audio to generate audio signatures and/or receive(s) codes embedded in the ambient audio to monitor media exposure at a location where the example meter(s) 102 is/are located. The example meter(s) 102 may include a modem interface (e.g., cellular, Wi-Fi, etc.) to communicate with the AME 108 via the network 106. The example meter(s) 102 may transmit metering data (e.g., collected media exposure data) to a media collection entity (e.g., the AME 108). In some examples, the meter(s) 102 include(s) a battery to temporarily operate if the meter(s) 102 do(es) not receive power from an outlet. In some examples, the meter(s) 102 can receive instructions from the AME 108 to perform updates, run diagnostics, and/or apply patches to software executed in memory of the meter(s) 102.

The example server(s) 104 of FIG. 1 provide(s) media and/or other content to users via the example network 106. For example, the server(s) 104 may correspond to webpages on the network 106. The server(s) 104 can provide media, data, and/or metadata that is displayed on a website. As further described below, the example AME 108 collects the media, data, and/or metadata on the server(s) 104 to identify contextual data that corresponds to a region and/or other regions that a person in the region may travel to (e.g., weather data, economic data, environmental data, political data, safety data, etc.). The AME 108 may target particular server(s) 104 based on various factors. For example, weather data may not be pulled from server(s) 104 for panel location and/or travel locations that have consistent weather patterns.

The example network 106 of FIG. 1 of FIG. 1 is a system of interconnected systems for exchanging data. The example network 106 may be implemented using any type of public or private network such as, but not limited to, the Internet, a telephone network, a local area network (LAN), a cable network, and/or a wireless network. To enable communication via the network 106, the example meter(s) 102 include(s) a communication interface that enables a connection to an Ethernet cable, a digital subscriber line (DSL), a telephone line, a coaxial cable, or any wireless connection, etc.

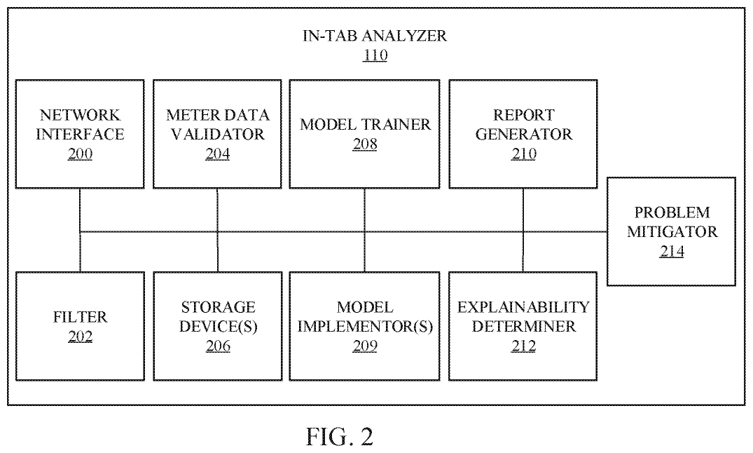

The example AME 108 of FIG. 1 represents an entity operating a server that collects metering data from the meter(s) 102 and contextual data from the example server(s) 104 via the network 106. The example AME 108 includes the example in-tab analyzer 110. The in-tab analyzer 110 includes a model (e.g., an AI-based system such as a neural network, a deep learning model, a machine learning model, etc.), that is trained based on validated in-tab data and corresponding contextual data. Once trained, the in-tab analyzer 110 uses the model to predict in-tab totals and/or in-tab drops for particular region(s) and/or region(s) based on the contextual data before the actual in-tab totals are received. In this manner, if an estimated in-tab total is below a threshold (e.g., based on a service level agreement), the AME 108 can generate a report and/or transmit a message to a client that warns the client of the estimated in-tab drop. Additionally, the example in-tab analyzer 110 may implement an explainability protocol to identify why the model estimated an in-tab drop. In this manner, the in-tab analyzer 110 can include the reasons for the estimated in-tab drop in the report to the client. Additionally, the example in-tab analyzer 110 may compare the estimated in-tab total and/or drop to the actual in-tab total and/or drop to determine if the actual in-tab total is less than the estimated in-tab total, which may signify a technical problem with the meter(s) 102. In this manner, the example in-tab analyzer 110 can transmit instructions to the example meter(s) 102 via the example network 106 to perform diagnostics to identify a problem and/or transmit instructions, patches, updated, etc. to mitigate a problem. In some examples, when the actual in-tab and estimated in-tab totals are close (e.g., within a threshold distance of each other) but they are both below the threshold agreed with the client, there may be an environmental/geosocial reason for the drop, not related to the technology. In such examples, the in-tab analyzer 110 can include reasons for the estimated in-tab drop in the report to the client voiding potential technical problems. The example in-tab analyzer 110 is further described below in conjunction with FIG. 2.

FIG. 2 is block diagram of an example implementation of the in-tab analyzer 110 of FIG. 1. The example in-tab analyzer 110 includes an example network interface 200, an example filter 202, an example meter data validator 204, example storage device(s) 206, an example model trainer 208, an example model implementor(s) 209, an example report generator 210, an example explainability determiner 212, and an example problem mitigator 214.

The example network interface 200 of FIG. 2 transmits and/or receives data to/from the example meter(s) 102 and/or the example server(s) 104 via the example network 106. For example, the network interface 200 may receive metering data from the example meter(s) 102. The example meter(s) 102 may transmit the metering data periodically (e.g., daily, weekly, etc.), aperiodically, and/or based on a trigger (e.g., instruction from the AME 108). For example, the network interface 200 may receive daily in-tab information (e.g., information corresponding to media exposure information determined by the meter(s) 102) from the in-tab meter(s) 102 via the network 106. Any of the meter(s) 102 that do not send information are considered out-of-tab. Additionally, the example network interface 200 may receive contextual information from one or more of the example servers 104 via the network 106. As described above, the contextual information may be any information that may correspond to in-tab drop (e.g., travel information, travel advertisements, weather data, political data, economic data, environmental initiatives, etc.) within one or more regions of interest. Additionally, the example network interface 200 may transmit instructions (e.g., diagnostic instructions and/or mitigation instructions), software updates, software patches, etc. to the example meter(s) 102 when it is estimated that one or more technical issues exist (e.g., to attempt to identify and/or mitigate the technical issue(s)).

The example filter 202 of FIG. 2 filters information (e.g., metering data from the meter(s) 102 and/or contextual data from the server(s) 104) corresponding to a particular location. For example, there may be a first model to be trained to estimate in-drop totals and/or drop for a first location (e.g., a country, a city, a state, etc.) and a second model to be trained to estimate in-drop totals and/or drop for a second location. Accordingly, the example filter 202 filters the obtained modeling data and/or contextual data so that the first model is trained based on modeling data and/or contextual data corresponding to the first location and the second model is trained based on modeling data and/or contextual data corresponding to the second location. Additionally, different locations may have different contextual data that affects in-tab drop. For example, because Medellin, Colombia has consistent weather year-round, local weather data will likely not be a factor for likelihood of residents of Medellin going on vacation and powering down a meter, leading to in-tab drop. Accordingly, the example filter 202 may filter out weather data for a model that estimates in-tab totals and/or drop for residents of Medellin. The type of contextual data that is to be utilized or factored out may be based on survey data, historical data, and/or based on prior AI training (e.g., the contextual data that correspond to the least significant weights of an AI model may be factored out). The example filter 202 may filter out the contextual data that is outside a threshold range of time corresponding to when the in-tab totals were received. In this manner, the contextual data statistically correlates to the time period of the in-tabs.

The example meter data validator 204 of FIG. 2 validates the metering data from the example meter(s) 102 to ensure that the collected metering data is valid and an accurate representation of the media exposure of the panel. In this manner, the model trainer 208 can use the validated metering data as truth or known data to train a model. The example data validator 204 may validate the data using a two prong approach. First, the example data validator 204 may determine if user and/or manufacturer defined criteria is met. For example, there may be criteria which states that if a household has more than one meter, then the metering data from the household is valid if more than a threshold number (e.g., all) of the meters in the household transmitted metering data to the AME 108. If the first prong is satisfied, the data validator 204 determines that the obtained metering data (e.g., the daily in-tabs) is valid if the network interface 200 has received metering data from more than a threshold percentage or number of meter(s) 102 that satisfy the criteria of prong one. In some examples, the example data validator 204 determine whether the metering data for a particular location is valid based on additional or alterative criteria.

The example storage device(s) 206 of FIG. 2 store(s) the validated in-tab data in conjunction with one or more particular regions and/or durations of time and/or contextual data in conjunction with the one or more particular regions and/or durations of time. In this manner, the in-tab data may be used in conjunction with contextual information corresponding to the same or similar region(s) and/or duration(s) of time to train one or more of the example models that may be implemented by the model implementor(s) 209, as further described below. Additionally, the example storage device(s) 206 may store estimated in-tab total(s) and/or drop(s) that the model implementor(s) 209 estimated. In this manner, the example report generator 210 and/or the problem mitigator 214 can compare the estimated in-tab drop and/or total to the actual in-tab drop and/or total. The example storage device(s) 206 may be separate storage devices (e.g., one of the metering data, one of the contextual data, and one for the in-tab estimates), may be a single storage device (e.g., for the metering data, contextual data, and in-tab estimates), and/or any combination thereof.

The example model trainer 208 of FIG. 2 trains the models (e.g., AI model(s), neural network(s), machine learning model(s), deep learning model(s), convolution neural network(s), another type(s) of AI-based model(s) and/or network(s)) stored in the example storage device(s) 206. Initially, a model(s) is/are untrained (e.g., the neurons are not yet weighted). The example model trainer 208 of FIG. 2 trains one or more models based on known (e.g. validated) metering data (e.g., as desired outputs) and corresponding contextual data (e.g., as inputs). The corresponding contextual data is obtained within a threshold amount of time from when the in-tab data was obtained. In some examples, the example model trainer 208 weights parameters of a model (e.g., a neuron of a neural network) to configure the model to predict in-tab totals and/or in-tab drop based on contextual data.

Once a model is trained, the example model implementor(s) 209 obtains contextual data corresponding to a particular location (which may or may not include contextual data for surrounding locations and/or highly travelled locations) and/or duration for time and, using the trained model, outputs an estimated in-tab total (e.g., total number of estimated in tab meters and/or total percentage of in-tab meters for the particular location and/or particular duration of time) and/or in-tab drop. In some examples, the model implementor(s) 209 are multiple implementers utilizing different models trained for different sets of metering data and/or contextual For example, there may be a first model implementor 209 to utilize a first model to predict in tab for a first location and a second model implementor 209 to utilize a second model to predict in-tab information for a second location, where the first location may or may not overlap (e.g., partially or fully) the second location. In such an example, the first location may be a first city and the second location may be a different city, a state that includes the first city, etc. In another example, the model implementor(s) 209 may utilize a first model trained to predict in-tab based on one set of contextual data and feed the output of the first model to a second model trained to predict in-tabs based on (a) the output from the first model and (b) additional contextual data relative to the same location. In some examples, the model implementor(s) 209 is a single model implementor that is capable of implementing multiple models stored in the storage device(s) 206.

The example report generator 210 of FIG. 2 generates a report including in-tab information. For example, if there is an estimated in-tab drop that will result in an estimated in-tab total that is below a threshold (e.g., defined in a service level agreement), the report generator 210 may generate a report indicating that the in-tab total will be low. In some examples, the report generator 210 indicates the reasons for the in-tab drop (e.g., based on the results of the explainability determiner 212 and/or based on an identification of one or more technical issues with the meter(s) 102). The report may include other media exposure information. The report may be a document and/or a data packet that includes the report. In this manner, the example network interface 200 can transmit the report to the client via the network 106.

The example explainability determiner 212 of FIG. 2 analyzes the estimation of in-tab drops and/or totals from the model implementor(s) 209 based on an input contextual data and generates an explainability report to identify the most important factors of the input contextual data used to generate the in-tab based output. The explainability determiner 212 may be implemented by Grad-CAM, Local Interpretable Model-Agnostic Explanations (LIME), algorithmic generalization, Deep Learning Important Features (DeepLIFT), layer-wise relevance propagation, and/or another explainability technique. In some examples, the explainability determiner 212 utilizes class-specific gradient information from the final convolution layer of the model implemented by the model implementor(s) 209 to generate a localization map (e.g., an explainability map) of the features of the input contextual data that were more important to the model when generating the output in-tab information.

The example problem mitigator 214 of FIG. 2 identifies and/or mitigates technical problems from the example meter(s) 102 of FIG. 1. For example, if the estimated in-tab total is more than the actual in-tab total, the example problem mitigator 214 determines that a technical issue and/or problem may be occurring at some or all of the example meters(s) 102. After the problem mitigator 214 identifies that a problem exists, the problem mitigator 214 attempts to identify and/or mitigate the problem. For example, the problem mitigator 214 may transmit diagnostic instructions to the example meter(s) 102 to attempt to identify what the problem is. Additionally or alternatively, the problem mitigator 214 may instruct the network interface 200 to transmit software updates, software patches, and/or other instructions to the meter(s) 102 via the network 106 to attempt to mitigate the problem. In another example, the estimated in-tab totals and actual in-tab totals are close (e.g., within a threshold) but are both below the threshold agreed with the client, indicating an external and/or environmental effect on in-tabs, not related to technical problems. When the example problem mitigator 214 confirms there is no technical problem, the network interface 200 can send a report voiding technical issues to the client providing the explanatory for the in-tab drop.

While an example manner of implementing the example in-tab analyzer 110 of FIG. 1 is illustrated in FIG. 2, one or more of the elements, processes and/or devices illustrated in FIGS. 1 and/or 2 may be combined, divided, re-arranged, omitted, eliminated and/or implemented in any other way. Further, the example network interface 200, the example filter 202, the example meter data validator 204, the example storage device(s) 206, the example model trainer 208, the example model implementor(s) 209, the example report generator 210, the example explainability determiner 212, the example problem mitigator 214, and/or, more generally, the example in-tab analyzer 110 of FIGS. 1 and/or 2 may be implemented by hardware, software, firmware and/or any combination of hardware, software and/or firmware. Thus, for example, any of the example network interface 200, the example filter 202, the example meter data validator 204, the example storage device(s) 206, the example model trainer 208, the example model implementor(s) 209, the example report generator 210, the example explainability determiner 212, the example problem mitigator 214, and/or, more generally, the example in-tab analyzer 110 of FIGS. 1 and/or 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example network interface 200, the example filter 202, the example meter data validator 204, the example storage device(s) 206, the example model trainer 208, the example model implementor(s) 209, the example report generator 210, the example explainability determiner 212, the example problem mitigator 214, and/or, more generally, the example in-tab analyzer 110 of FIGS. 1 and/or 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example in-tab analyzer 110 of FIGS. 1 and/or 2 may include one or more elements, processes and/or devices in addition to, or instead of, those illustrated in FIGS. 1 and/or 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

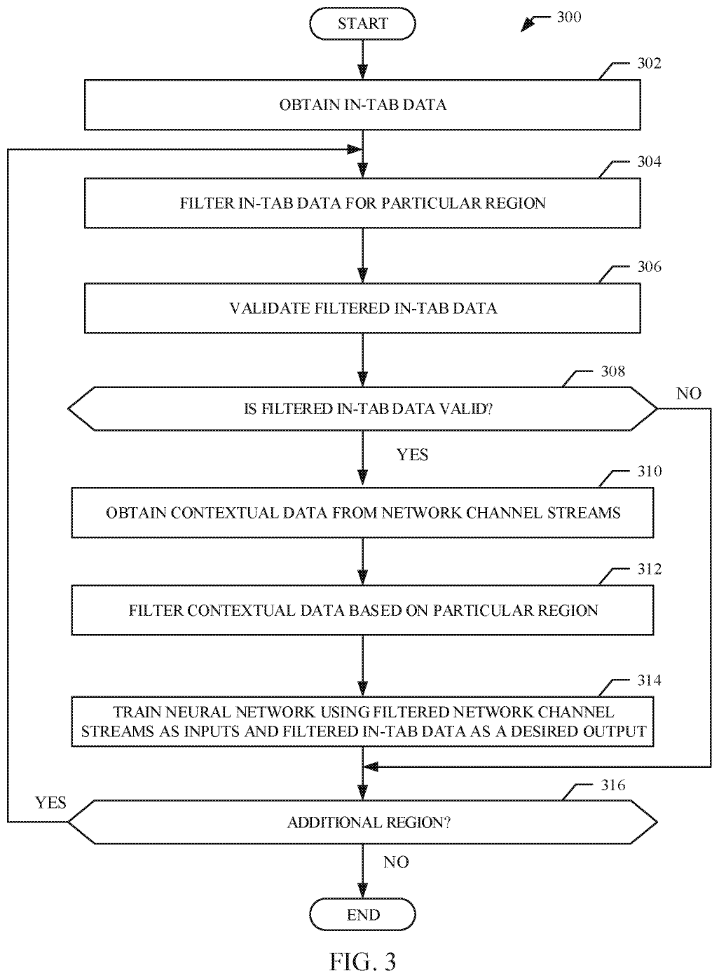

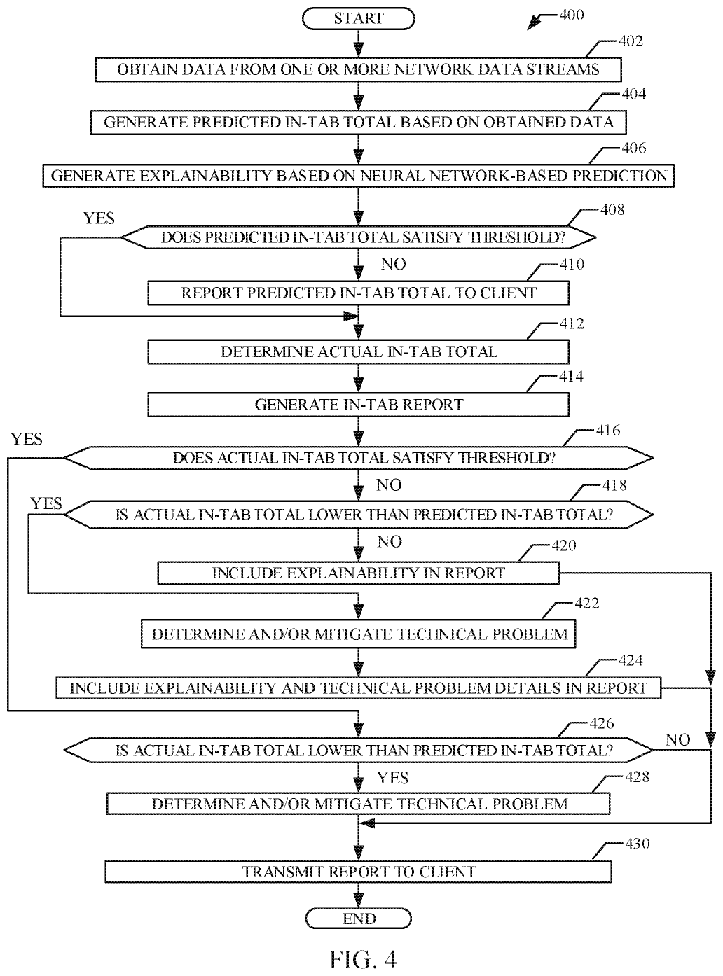

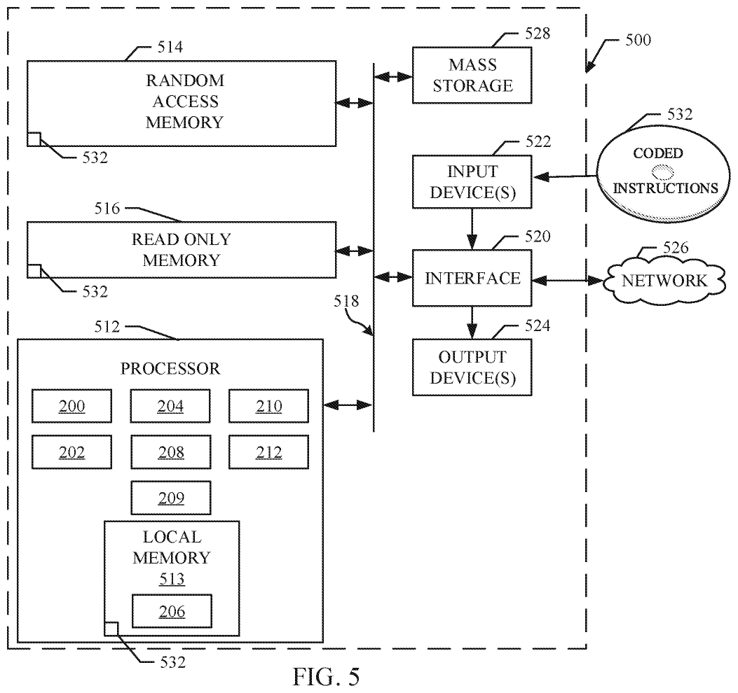

Flowcharts representative of example hardware logic, machine readable instructions, hardware implemented state machines, and/or any combination thereof for implementing the example in-tab analyzer 110 of FIGS. 1 and/or 2 are shown in FIGS. 3-4. The machine readable instructions may be one or more executable programs or portion(s) of an executable program for execution by a computer processor such as the processor 512 shown in the example processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowcharts illustrated in FIG. 5 many other methods of implementing the example in-tab analyzer 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3-4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is an example flowchart representative of machine readable instructions 300 that may be executed to implement the example in-tab analyzer 110 of FIG. 2 to train one of the models for a particular location. Although the instructions 300 are described in conjunction with the example in-tab analyzer 110 of FIG. 2, the instructions 300 may be described in conjunction with any type of in-tab analyzer.

At block 302, the example network interface 200 obtains in-tab data from the example meter(s) 102. In some examples, the network interface 200 may obtain in-tab data (e.g., media exposure data that has been received from in-tab meters) at a periodic interval (e.g., daily in-tabs). At block 304, the example filter 202 filters the in-tab data for a particular region. The particular region may be based on the service level agreement with the client. The location could be one or more regions and/or all regions. Accordingly, the example filter 202 filters out the data based on the corresponding region(s) and/or may not filter out any data if based on all regions. At block 306, the example meter data validator 204 validates the filtered in-tab data. As described above in conjunction with FIG. 2, the meter data validator 204 can validate the filtered in-tab data based on preset criteria that corresponds to statistically valid meter data.

At block 308, the example meter data validator 204 determines if the filtered in-tab data is valid based on the validation criteria. If the example meter data validator 204 determines that the filtered in-tab data is not valid (block 308: NO), control continues to block 316. If the example meter data validator 204 determines that the filtered in-tab data is valid (block 308: YES), the example network interface 200 obtains contextual data from network contextual data sources (block 310). The network contextual data sources corresponds to groups of the server(s) 104 that correspond to a particular type of contextual data. For example, weather data may be obtained from a group of the server(s) 104 that include weather data, environmental policy data may be obtained from a group of the server(s) 104 that correspond to environmental policy, etc. The number and/or type of network channel streams may be based on user preferences, manufacturer preferences, the service level agreement, historical data, etc. The contextual data is obtained (e.g., and/or filtered to include data from) within a threshold range of time around when the in-tab totals were obtained.

At block 312, the example filter 202 filters the contextual data based on the particular region. For example, the filter 202 may filter the contextual data to include contextual data (e.g., travel advertisements and/or travel sales, weather data, political data, economic data, environmental data) from the particular reason that may cause panelists or external factors (e.g., power outages) to power down meters. Additionally, the filter 202 filters the contextual data to include contextual data of neighboring locations and/or locations that are historically traveled to by residents of the particular area to predict in-tab drop due to vacationing. For example, if residents of a particular region have historically travelled to tourist beach locations, the filter 202 may filter the contextual data to include data related to the tourist beach locations (e.g., safety data, weather data, economic data, etc.).

At block 314, the example model trainer 208 trains a model using the filtered network channel streams as inputs and the validated in-tab data as desired output. The in-tab data may be the total number and/or percentage of in-tab household, meters, and/or panelists or the in-tab data may be the in-tab drop from the current period of time to a previous period of time. As described above in conjunction with FIG. 2, the model trainer 208 may be train the model by adjusting weights of parameters so that the input contextual data results in the corresponding in-tab output data. At block 316, the example filter 202 determines if there is at least one additional region (e.g., location that are part of a service level agreement) that need to be processed to train an additional model. If the example filter 202 determiners that there is at least one additional region to process (block 316: YES), control returns to block 304. If the example filter 202 determiners that there are no additional regions to process (block 316: NO), the process ends.

FIG. 4 is an example flowchart representative of machine readable instructions 400 that may be executed to implement the example in-tab analyzer 110 of FIG. 2 to estimate in-tab totals and/or drops using a trained model for a particular location and generating a report and/to mitigating a technical problem based on the estimation. Although the instructions 400 are described in conjunction with the example in-tab analyzer 110 of FIG. 2, the instructions 300 may be described in conjunction with any type of in-tab analyzer.

At block 402, the example network interface 200 obtains data (e.g., contextual data) from one or more network contextual data sources. The particular network streams (e.g., servers corresponding to weather data, servers corresponding to political data, etc.) may be based on the service level agreement, historical data, manufacturer preferences, the particular location that is being monitored, etc. At block 404, the example model implementor 209 generates a predicted (e.g., estimated) in-tab total for a subsequent duration of time (e.g., a next day, a next, week, a next month) based on the obtained contextual data using a model corresponding to the particular location. As described above in conjunction with FIG. 2, once the example model is trained, the model implementor 209 can implement the model to estimate in-tab totals based on contextual data that is input into the model. The example report generator 210 can determine an in-tab drop based on the in-tab total and a previous in-tab total. In some examples, the model implementor 209 trains the model to output an in-tab drop from a previous in-tab total. In such example, the model implementor 209 may output an in-tab drop when implementing the model.

At block 406, the example explainability determiner 212 generates explainability (e.g., a graph, a report, data, etc.) based on the model-based prediction. As described above in conjunction with FIG. 2, the explainability determiner 212 analyzes the model implemented by the model implementor 209 (e.g., the last layer(s) of a neural network) in the generation of the in-tab prediction to identify one or more factors that were considered important (e.g., based on a threshold) when generating the in-tab prediction. Accordingly, the explainability determiner 212 generates the explainability to identify the one or more factors that were significant in the prediction. At block 408, the example report generator 210 determines if the predicted in-tab total satisfies a threshold (e.g., the threshold agreed to in the service level agreement). If the example report generator 210 determines that the predicted in-tab totals satisfies the threshold (block 408: YES), control continues to block 412. If the example report generator 210 determines that the predicted in-tab totals does not satisfy the threshold (block 408: NO), the report generator 210 generates a report (e.g., signal, alert, spreadsheet, document, data packet, etc.) indicating the predicted in-tab total to the client (block 410). In this manner, the example network interface 200 can transmit an alert to the client to warn them of a potential in-tab drop prior to an actual in-tab drop.

At block 412, the example filter 202 determines the actual in-tab total for the duration of time corresponding to the predicted in-tab total. To determine the actual in-tab total, the network interface 200 obtains the in-tab data for the subsequent duration of time and the filter 202 filters out the in-tab data (e.g., after being validated by the example meter data validator 204) to keep the in-tab data that corresponds to the particular region of interest to identify the in-tab total for the particular region of interest. In some examples, the example filter 202 compares the total number of in-tab households, meters, and/or panelists to the total number of panelist households, meters, and/or panelists in the particular region to identify the actual in-tab total and/or percentage.

At block 414, the example report generator 210 generates an initial in-tab report that includes the actual in-tab total, an in-tab drop (e.g., based on a comparison of the actual in-tab total to a previous actual in-tab total). The report may be a word document, a data packet or data signal, a spreadsheet, a graph, an image, an indicator, and/or any other way to convey data. At block 416, the example report generator 210 determines if the actual in-tab total satisfies a threshold (e.g., the threshold number of in-tabs as set forth in a service level agreement). If the actual in-tab total satisfies the threshold (block 416: YES), control continues to block 422. If the actual in-tab total does not satisfy the threshold (block 416: NO), the example report generator 210 determines if the actual in-tab total is lower than the predicted in-tab total (block 418).

If the example report generator 210 determines that the actual in-tab total is not lower than the predicted in-tab total (block 418: NO), the example report generator 210 includes the explainability data in the report (block 420). In this manner, the reasons why the actual in-tab total is below the threshold can be provided to the client. As described above, in some examples, if the actual in-tab total and the estimated in-tab total are within a threshold distance of each other and the totals are both below the threshold defined by the client and/or contract, the network interface 200 may transmit a report to the client that indicates an environmental and/or geosocial reason for the in-tab drop as opposed to a technical issue. In such examples, the problem mitigator 206 may verify that there is no technical issue prior to sending the report.

However, if the actual in-tab total is lower than the predicted in-tab total, there may also be a technical problem with the meter(s) 102 that is also responsible for the in-tab drop. Accordingly, if the report generator 210 determines that the actual in-tab total is lower than the predicted in-tab total (block 418: YES), the problem mitigator 214 determines (e.g., identifies) and/or mitigates one or more technical problems of the example meter(s) 102 (block 422). For example, the problem mitigator 214 may send alarm messages to the support team or communicate with and/or send instructions to the meter(s) 102 via the network interface 200 to attempt to identify one or more technical problems (e.g., by instructing the meter(s) 102 to perform particular tasks, diagnostics, etc.) and/or may attempt to mitigate one or more problems by transmitting instructions (e.g., to reset, reboot, etc.), software updated, software patches, etc. At block 424, the example report generator 210 includes the explainability details and the technical problem details (e.g., identified issue(s), step(s) to mitigate issue(s), whether the problem was resolved or not, etc.) in the report. In this manner, the reasons why the actual in-tab total is below the threshold as well as the technical problems and/or resolutions can be provided to the client.

Although, the actual in-tab total may satisfy the threshold, there still may be a technical problem in one or more of the server(s) 104 that can be mitigated. Accordingly, the example report generator 210 determines that the actual in tab, total satisfies the threshold (block 416: YES), the example report generator 210 determines if the actual in-tab total is lower than the predicted in-tab total (block 426). If the report generator 210 determines that the actual in-tab total is not lower than the predicted in-tab total (block 426: NO), control continues to block 430. If the report generator 210 determines that the actual in-tab total is lower than the predicted in-tab total (block 426: YES), the problem mitigator 214 determines (e.g., identifies) and/or mitigates one or more technical problems of the example meter(s) 102 (block 428). For example, the problem mitigator 214 may communicate with and/or send instructions to the meter(s) 102 via the network interface 200 to attempt to identify one or more technical problems (e.g., by instructing the meter(s) 102 to perform particular tasks, diagnostics, etc.) and/or may attempt to mitigate one or more problems by transmitting instructions (e.g., to reset, reboot, etc.), software updated, software patches, etc. At block 430, the example network interface 200 transmits the report to the client.

FIG. 5 is a block diagram of an example processor platform 500 structured to execute the instructions of FIGS. 3 and/or 4 to implement the in-tab analyzer 110 of FIG. 2. The processor platform 500 can be, for example, a server, a personal computer, a workstation, a web plugin tool, a self-learning machine (e.g., a neural network), a mobile device (e.g., a cell phone, a smart phone, a tablet such as an iPad™), an Internet appliance, or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example network interface 200, the example filter 202, the example meter data validator 204, the example model trainer 208, the example model implementor(s) 209, the example report generator 210, the example explainability determiner 212, and the example problem mitigator 214.

The processor 512 of the illustrated example includes a local memory 513 (e.g., a cache). In this example, the local memory 513 implements the example storage device(s) 206. The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAIVIBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIGS. 3-4 may be stored in the mass storage device 528, in the volatile memory 514, in the non-volatile memory 516, and/or on a removable non-transitory computer readable storage medium such as a CD or DVD.

From the foregoing, it will be appreciated that example methods, apparatus and articles of manufacture have been disclosed that predict in-tab drop using artificial intelligence. The disclosed methods, apparatus and articles of manufacture are able to predict in-tab drop before it occurs. Additionally, examples disclosed herein is able to use in-tab predictions as an indicator of technical problems at meter(s) and respond to mitigate the technical problems. Additionally, examples disclosed herein utilize explainability information to identify one or more factors that correspond to an in-tab drop. Explainability information enables a reduction of subsequent computing cycles to contact panelists to confirm that there was a power outage, for example. In this manner, utilizing explainability can reduce computing resources associated with contacting panelists when a device goes out of tab, reduce panelist frustration from being contacted, etc. Accordingly, the disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
an interface to obtain (A) contextual data obtained from a server and (B) validated in-tab totals, the validated in-tab totals corresponding to a number of meters in a location that have transmitted metering data within a threshold duration of time;
a filter to filter at least one of the contextual data based on the location; and
a model trainer to train a model using filtered contextual data and the validated in-tab totals, the model trainer to train the model to estimate an in-tab total for the location based on input contextual data corresponding to the location.

2. The apparatus of claim 1, wherein the contextual data includes that that corresponds to information that may result in a meter dropping out-of-tab.

3. The apparatus of claim 1, wherein the threshold duration of time is a first threshold duration of time, the contextual data corresponding to a second threshold duration of time from when the validated in-tab totals were obtained.

4. The apparatus of claim 1, further including:
a model implementor to implement the model to estimate the in-tab total for the location based on the input contextual data corresponding to the location;
a report generator to, when the estimated in-tab total is below a threshold, generate a report including the estimated in-tab total; and
the interface to transmit the report.

5. The apparatus of claim 4, wherein the filter is to determine an actual in-tab total for the location, the report generator to compare the actual in-tab total to the estimated in-tab total.

6. The apparatus of claim 5, further including a problem mitigator to identify a technical issue with a meter of the meters when the estimated in-tab total is lower than the actual in-tab total.

7. The apparatus of claim 5, further including a problem mitigator to mitigate a technical issue with a meter of the meters when the estimated in-tab total is lower than the actual in-tab total.

8. The apparatus of claim 4, further including an explainability determiner to determine explainability information identifying a factor that the model relied on in determining the estimation.

9. A non-transitory computer readable storage medium comprising instructions which, when executed, cause one or more processors to at least:
obtain (A) contextual data obtained from servers and (B) validated in-tab totals, the validated in-tab totals corresponding to a number of meters in a location that have transmitted metering data within a threshold duration of time;
filter at least one of the contextual data based on the location; and
train a model using filtered contextual data and the validated in-tab totals, the trained model to estimate an in-tab total for the location based on input contextual data corresponding to the location.

10. The computer readable storage medium of claim 9, wherein the contextual data includes that that corresponds to information that may result in a meter dropping out-of-tab.

11. The computer readable storage medium of claim 9, wherein the threshold duration of time is a first threshold duration of time, the contextual data corresponding to a second threshold duration of time from when the validated in-tab totals were obtained.

12. The computer readable storage medium of claim 9, wherein the instructions, when executed, cause the one or more processors to:
implement the model to estimate the in-tab total for the location based on the input contextual data corresponding to the location;
in response to the estimated in-tab total being below a threshold, generate a report including the estimated in-tab total; and
transmit the report.

13. The computer readable storage medium of claim 12, wherein the instructions cause the one or more processors to:
determine an actual in-tab total for the location; and
compare the actual in-tab total to the estimated in-tab total.

14. The computer readable storage medium of claim 13, wherein the instructions cause the one or more processors to identify a technical issue with a meter of the meters when the estimated in-tab total is lower than the actual in-tab total.

15. The computer readable storage medium of claim 13, wherein the instructions cause the one or more processors to mitigate a technical issue with a meter of the meters when the estimated in-tab total is lower than the actual in-tab total.

16. The computer readable storage medium of claim 12, wherein the instructions cause the one or more processors to determine explainability information identifying a factor that the model relied on in determining the estimation.

17. A method comprising:
obtaining (A) contextual data obtained from servers and (B) validated in-tab totals, the validated in-tab totals corresponding to a number of meters in a location that have transmitted metering data within a threshold duration of time;
filtering at least one of the contextual data based on the location; and
training a model using filtered contextual data and the validated in-tab totals, the trained model to estimate an in-tab total for the location based on input contextual data corresponding to the location.

18. The method of claim 17, wherein the contextual data includes that that corresponds to information that may result in a meter dropping out-of-tab.

19. The method of claim 17, wherein the threshold duration of time is a first threshold duration of time, the contextual data corresponding to a second threshold duration of time from when the validated in-tab totals were obtained.

20. The method of claim 17, further including:
implementing the model to estimate the in-tab total for the location based on the input contextual data corresponding to the location;
when the estimated in-tab total is below a threshold, generating a report including the estimated in-tab total; and
transmitting the report.
